(19) United States
(12) Patent Application Publication
(10) Pub. No.: US 2013/0293185 A1
(43) Pub. Date: Nov. 7, 2013

(54) HIGH CURRENT BATTERY CHARGING USING IR DROPOUT COMPENSATION

(71) Applicants: Todd R. Sutton, Del Mar, CA (US); Cheong Kun, San Diego, CA (US); Dennis Joe Cashen, San Diego, CA (US)

(72) Inventors: Todd R. Sutton, Del Mar, CA (US); Cheong Kun, San Diego, CA (US); Dennis Joe Cashen, San Diego, CA (US)

(73) Assignee: QUALCOMM INCORPORATED, San Diego, CA (US)

(21) Appl. No.: 13/464,266

(22) Filed: May 4, 2012

(51) Int. Cl. H02J 7/00

(52) U.S. Cl. 320/107; 320/162; 320/152

(57) ABSTRACT

A method, apparatus, and non-transitory computer readable medium are provided for high current battery charging using IR dropout compensation. The method first measures a battery current value and then multiplies that battery current value by an effective resistance of the battery to produce an effective dropout voltage value. The effective battery voltage value is then compared with a desired battery top off voltage value. The switch mode battery charger output setpoint is adjusted based on the setpoint voltage. Battery current and terminal current are then compared. Charging is terminated if the battery current is less than the terminal current. If the battery current is greater than the terminal current the battery current value is measured again and the charging process continues until the condition is met.

### BACKGROUND

1. Field

The present disclosure relates generally to communication systems, and more particularly, to high current battery charging using IR dropout compensation.

2. Background

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include code division multiple access (CDMA) systems, time division multiple access (TDMA) systems, frequency division multiple access (FDMA), 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, where N_{S}_{_{—}}≧min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when the multiple antennas are available at the base station. In an FDD system, forward and reverse link transmissions are on different frequency regions.

As mobile devices have begun to perform more functions, the need for battery power becomes more important and the ability to charge a battery also become much more important. Most mobile devices manufactured today rely on lithium-ion batteries for power.

Lithium-ion batteries commonly require a constant current, constant voltage charging algorithm. A lithium-ion battery should be charged at a set current level (typically from 1 to 1.5 amperes) until it reaches its final voltage. At this point, the charger circuitry should switch over to constant voltage mode and provide the current necessary to hold the battery at this final voltage (typically at 4.2 V per cell). The charger must be capable of providing stable control loops for maintaining either current or voltage at a constant value, depending on the state of the battery. There is a need in the art for a method and apparatus for charging to a battery's full capacity without overcharging.

### SUMMARY

An embodiment provides a method for high current battery charging using IR dropout compensation. The method comprises the steps of measuring a battery current value; multiplying the battery current value by an effective resistance of the battery to produce an effective dropout voltage value; comparing the effective battery voltage value with a desired battery top off voltage value; adjusting a switch mode battery charger output setpoint based on a setpoint voltage; comparing the battery current with the terminal current; and terminating charging if the battery current is less than the terminal current, and measuring the battery current value again if the battery current is greater than the terminal current.

An additional embodiment provides a further method for charging a lithium-ion battery. This embodiment senses a battery voltage using a Kelvin sense at positive and negative terminals of the battery and then comparing the sensed battery voltage value with a desired battery top off voltage value. Charging is terminated if the battery voltage exceeds the desired battery top of voltage and continues if the battery voltage does not exceed the desired battery top of value.

A further embodiment provides an apparatus for high current battery charging using IR dropout compensation. The apparatus includes a battery field effect transistor, a switch mode battery charger; a comparator, a battery management system, a multiplier; and a processor for performing the required computations.

Yet a further embodiment provides an apparatus for charging a lithium-ion battery. The apparatus includes: means for measuring a battery current value; means for multiplying the battery current value by an effective resistance of the battery to produce an effective dropout voltage value; means for comparing the effective battery voltage value with a desired battery top off voltage value; means for adjusting a switch mode battery charger output setpoint based on a setpoint voltage; means for comparing battery current and terminal current; and means for terminating charging if the battery current is less than the terminal current; and means for measuring the battery current value again if the battery current is greater than the terminal current.

Yet a further embodiment provides an apparatus for charging a lithium-ion battery. The apparatus includes means for sensing a battery voltage using a Kelvin sense at both positive and negative terminals of the battery; means for comparing the sensed battery voltage value with a desired battery top off voltage value; and means for terminating charging if the battery voltage exceeds the desired battery top of value; and means for continuing charging if the battery voltage does not exceed the desired battery top of value.

A still further embodiment provides a non-transitory computer-readable medium containing instructions for causing a processor to perform the steps of: measuring a battery current value; multiplying the battery current value by an effective resistance of the battery to output an effective dropout voltage value. The processor then directs a comparison of the effective resistance of the battery voltage value with a desired battery top off voltage value. The switch mode battery charger output setpoint is adjusted based on a setpoint voltage. The battery current and terminal current are then compared and charging is terminated if the battery current is less than the terminal current, and continues if the battery current is greater than the terminal current.

An additional embodiment provides a non-transitory computer-readable medium containing instructions for causing a processor to perform the steps of: sensing a battery voltage via a desired Kelvin sense at both the positive and negative terminals of the battery. Next, the processor directs a comparison of the sensed battery voltage value with a desired battery top off voltage value. Charging is terminated if the battery voltage exceeds the desired battery top off value and continues if the battery voltage does not exceed the desired battery top off value.

### BRIEF DESCRIPTION OF THE DRAWINGS

FIG. 1 illustrates a multiple access wireless communication system, in accordance with certain embodiments of the disclosure.

FIG. 2 illustrates a block diagram of a communication system in accordance with certain embodiments of the disclosure.

FIG. 2A illustrates a high level overview of a high current battery charging system using IR dropout compensation.

FIG. 3 depicts a conventional charging system using IR dropout compensation.

FIG. 4 depicts an high current battery charging system using IR dropout compensation according to an embodiment of the disclosure.

FIG. 5 depicts a further embodiment of a high current battery charging system using IR dropout compensation.

FIG. 6 is a flowchart of a method for high current battery charging using IR dropout compensation.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

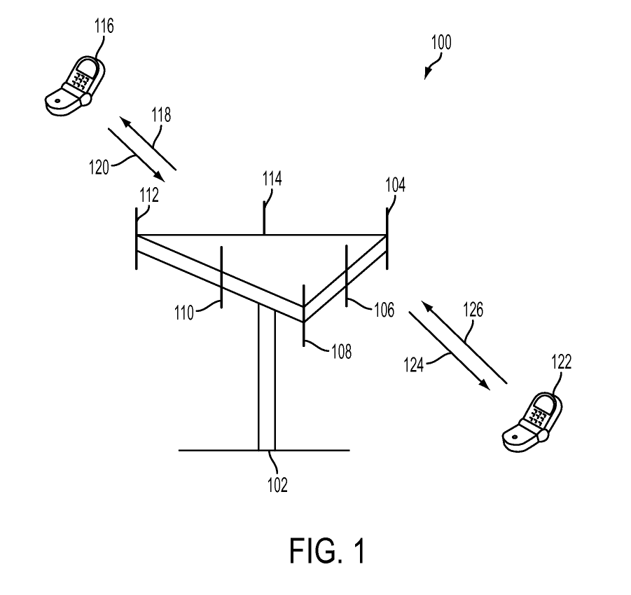

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124 and receive information from access terminal 122 over uplink or reverse link 126. In a Frequency Division Duplex (FDD) system, communication links 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups each are designed to communicate to access terminals in a sector of the areas covered by access point 102.

In communication over downlinks or forward links 118 and 124, the transmitting antennas of access point utilize beamforming in order to improve the signal-to-noise ratio (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102, or the access terminals 116, 122 may utilize the proposed transmit echo cancellation technique to improve performance of the system.

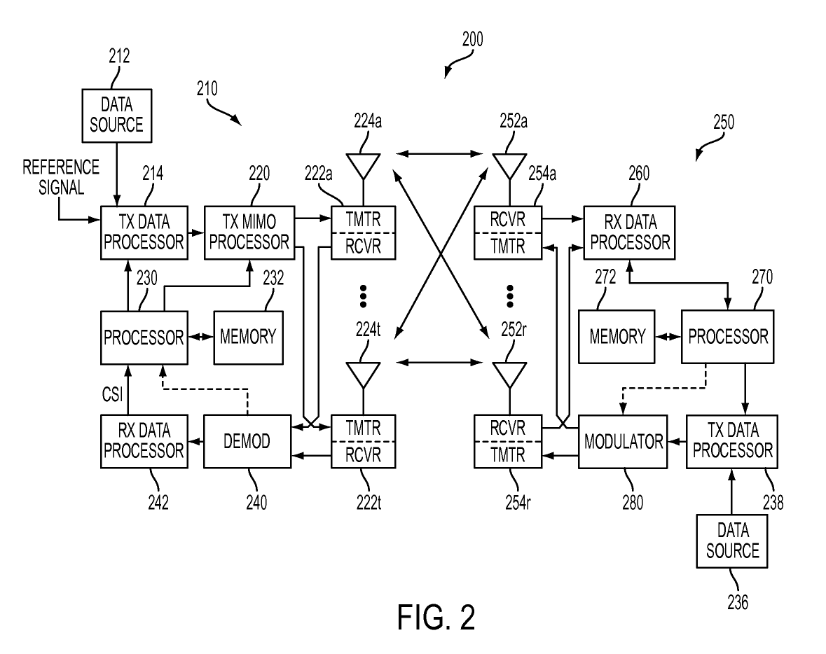

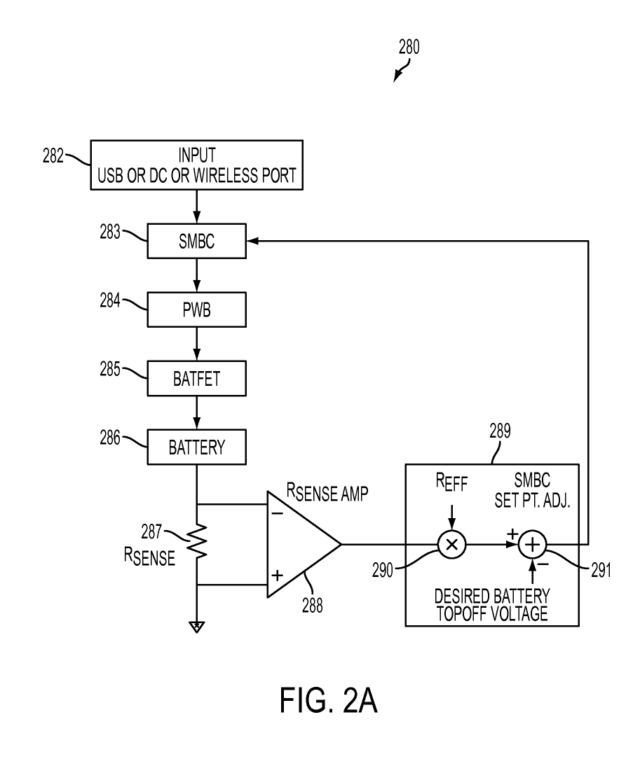

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214. An embodiment of the disclosure is also applicable to a wireline (wired) equivalent of the system shown in FIG. 2.

In an aspect, each data stream is transmitted over a respective transmit antenna. TX data processor 214 formats, codes, and interleaves the traffic data for each data stream based on a particular coding scheme selected for that data stream to provided coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular based on a particular modulation scheme (e.g. a Binary Phase Shift Keying (BPSK), Quadrature Phase Shift Keying (QPSK), M-PSK in which M may be a power of two, or M-QAM, (Quadrature Amplitude Modulation)) selected for that data stream to provide modulation symbols. The data rate, coding, and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by the N_{R} antennas 252a through 252r and the received signal from each antenna 252 is provided to a respective receiver (RCVR) 254a through 254r. each receiver 254 conditions (e.g., filters, amplifies, and downconverts) a respective received signal, digitizes the conditioned signal to provide samples, and further processes the samples to provide a corresponding “received” symbol stream.

A RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX processor 260 is complementary to that performed by TX MIMO processor 220 and TX data processor 214 at transmitter system 210.

Processor 270, coupled to memory 272, formulates a reverse link message. The reverse link message may comprise various types of information regarding the communication link and/or the received data stream. The reverse link message is then processed by a TX data processor 238, which also receives traffic data for a number of data streams for ma data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250.

The operations of the mobile device described above require sufficient battery power to perform the functions. Most mobile devices utilize lithium-ion batteries. Lithium-ion batteries require a constant current, constant voltage charging algorithm. A lithium-ion battery should be charged at a set current level, which is typically from 1 to 1.5 amperes until the battery reaches its final voltage. Once the final voltage is reached, the charger circuitry should switch over to constant voltage mode and provide the current necessary to maintain the battery at this final voltage. The final voltage is typically 4.2 V per cell. The charger must be capable of providing stable control loops to maintain either current or voltage at a constant value, depending on the state of the battery.

The challenge in charging a lithium-ion battery is to achieve the battery's full capacity without overcharging it. Overcharging may result in a catastrophic failure. There is little room for error as lithium-ion batteries have a ±1% margin. Overcharging by more than 1% could result in battery failure, while undercharging by more than 1% results in reduced capacity. Since the margin for error is so small, high accuracy is required from the charging control circuitry. In order to achieve this accuracy, the controller must have a precision voltage reference, a low-offset high gain feedback amplifier, and an accurately matched resistance divider. The combined errors of all these components must result in an overall error less than ±1%.

Battery voltage is not being measured correctly because of the printed wiring board (PWB), battery field effect transistor (BATFET), and the sensing line resistance (RSense) losses cause the measured voltage to be higher than it actually is at the battery terminals. This causes slower charging since the transition from constant current to constant voltage charging mode will occur earlier than desired. This is particularly true for two wire and three wire measuring systems. All two wire and three wire measuring systems are subject to measurement errors due to current voltage (IR) drop in the sense wires to a device. This occurs regardless of whether resistance, voltage, or current is being measured. A four wire system offers the ability to remove all effects of IR drop. In a four wire measurement system two sense lines, one on either side of the component being measured, are connected to a very high impedance (>10M ohms) inputs of the measuring device. This very high impedance input limits the current flow or IR drop to below micro-volts in the sense lines. This four wire measurement approach using very high impedance sense lines is known as a Kelvin sense measurement.

FIG. 2A provides a high level overview of a high current battery charging system using IR dropout compensation. The apparatus 280 accepts the input of the USB or DC or wireless port 282 and inputs it to the switch mode battery charger (SMBC) 283. The SMBC then processes the input and passes the result to the printed wiring board (PWB) 284. The PWB passes the computed value to the battery field effect transistor (BATFET) 205. BATFET 285 is connected to battery 206. Battery 206 is connected to resistor, Rsense 287. Rsense 287 provides positive and negative inputs to Rsense amplifier 288. Rsesnse amplifier 283 provides an input to the high level operating system 289. High level operating system 289 incorporates multiplier 290 and adder 291. The high level operating system 289 may be implemented in hardware or software.

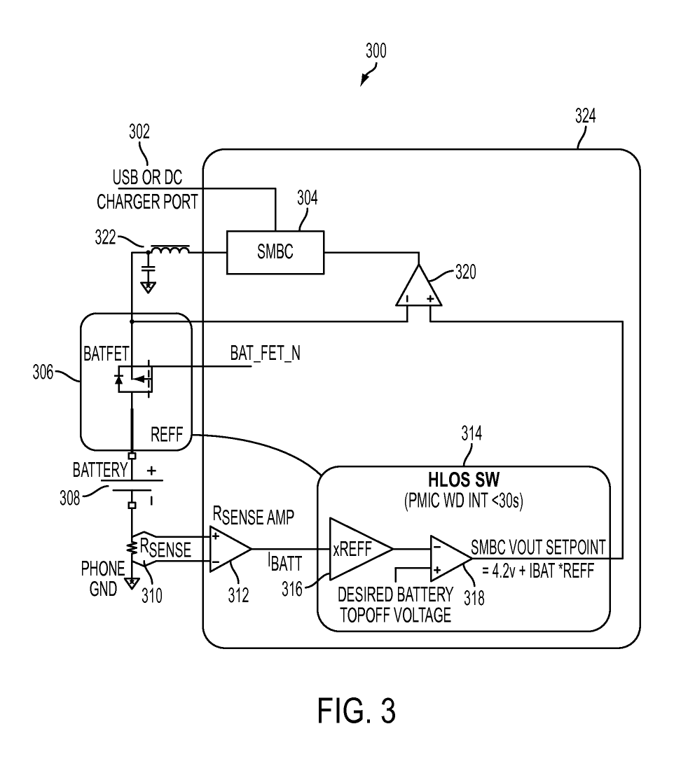

FIG. 3 illustrates a high current charging circuit 300 with IR drop components that is currently used in a power management chip 324. Both the battery pack and the accumulation of the printed wiring board (PWB) traces affect the battery charging function. In an embodiment, the switch mode battery charger (SMBC) output voltage to change the battery current. Alternatively, power management chip 324 uses an external battery field effect transistor (BATFET) 306 to control the current charging of the battery. Power management chip 324 also employs an external in-line current measuring resistor 310 to measure the current through the battery 308. This current measuring resistor 310 accurately measures the current. Table 1 shows the calculations and the minimum and maximum current drop voltages, calculated as I×R=V, of the printed wiring board traces. Reff used in this context is the sum of the PWB resistance, battery FET, resistance drain to source in the on state (Rdson), and Rsense.

Charging is accomplished through charger port 302, which may be either a universal serial bus input or a DC input port. This charger port 302 provides a current voltage source. Charger port 302 is connected to switch mode battery charger (SMBC) 304 located internally in power management chip 324. SMBC 304 utilizes a voltage set point. The SMBC 304 is connected to the charger port 302 and also to the LC power line filter 322. Once charging reaches the voltage set point in the SMBC, the current is dropped to a trickle charge level. The SMBC voltage set point is calculated using the following formula:

4.2v+Ibat(measured)×Reff(calculated)=Vset

In a power management chip 324 using present technology, due to the printed wiring board resistance adjusting the SMBC voltage set point, setting the voltage set point higher provides only a limited, improvement for a 47 miliohm Reff and a 2 amp battery charging current. In an embodiment, a 50% reduction in total charging time by remaining in charge current mode longer. This is in contrast to other methods which lengthen the time spent in the charge current mode and the inefficient time spent with SMBC output voltage greater than the charging termination voltage .

The SMBC LC filter 322 is also connected to the BATFET 306. BATFET 306 is in turn connected to battery 308. SMBC 304 provides an input to comparator 320. The SMBC's output is fed back into the error comparator 320.

Currently flowing through the battery also flows through Rsense 310 which develops a voltage (Ibat x Rsense) across Rsense 310 which is corrected to and measured by a high impedance amplifier 312. This value represents Ibat. Ibat is then multiplied by Reff 316 to represent the estimated Ibatt x Reffdrop seen by the system. This is compared to the desired battery voltage setpoint in comparator 318. This produces an error to be used by error comparator 320 to control the SMBC output voltage setpoint. Thus there are two loops here: an inner loop from SMBC 304, LC power line filter 322, comparator 320, to an outer loop from SMBC 304, LC filter 322, BATFET 306, battery 308, Rsense resistor 310, Rsense amplifier 312, xReff 316, high level operating system 314, software comparator 318, and comparator 320.

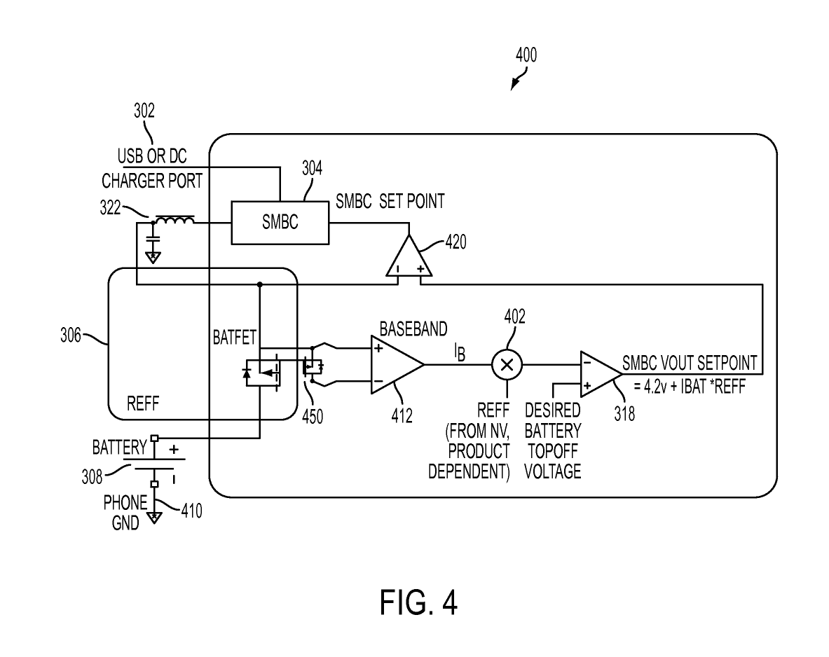

FIG. 4 illustrates an embodiment of a high current charging circuit with IR dropout compensation. In contrast with the example depicted in FIG. 3, the BATFET is internal to the power management chip 400. Charging is accomplished through charger port 302, which may be either a universal serial bus a DC input port, or a wireless charging port. Charger port 302 is connected to switch mode battery charger (SMBC) 304 and the SMBC's LC filter 322 The current through BATFET 306 is mirrored in BATFET current resistor 450 and used by the current sense amplifier 312 to represent That. That is multipled by Reff to create the voltage drop Vdrop=Reff x That and compared to the desired battery setpoint voltage 318. This setpoint error is used by the SMBC setpoint comparator 420 to feed an adjusted setpoint to the SMBC 304. This may be represented by the formula below::

SMBC Vout Setpoint=4.2v+Ibat*Reff

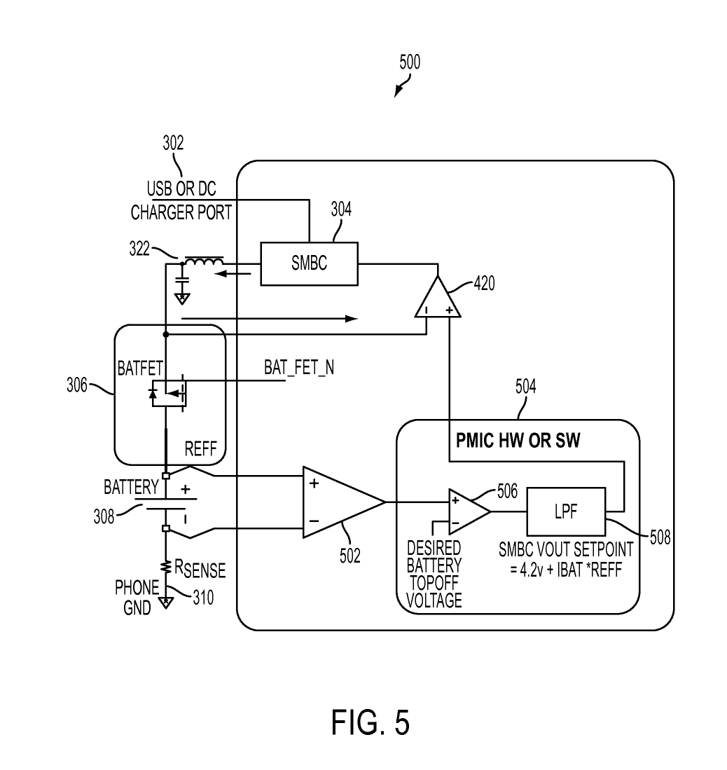

FIG. 5 illustrates a further embodiment of a high current battery charging system using IR dropout compensation. This embodiment provides for a four wire Kelvin high impedance sense system to measure the battery voltage. This eliminates the printed wiring board IR drops. This embodiment allows very precise measurements and allows hardware or software to compensate for impedances internal to the battery. The high current battery charging system 500 uses an external BATFET 306 to control the current charging of the battery 308. Battery 308 is connected to differential amplifier 502. Differential amplifier 502 amplifies the voltage and inputs the result to software module 504. Software module 504 includes comparator 506 which compares the desired battery voltage with the top off value. The comparator output is passed to low pass filter 508. The output of the low pass filter 508 is passed to comparator 520, which in turn passes the result to SMBC 304. Comparator 420 is also connected with BATFET 306.

The embodiment depicted in FIG. 5 eliminates the printed wiring board IR drops. This embodiment addresses the IR drop comprised of the contact resistance.

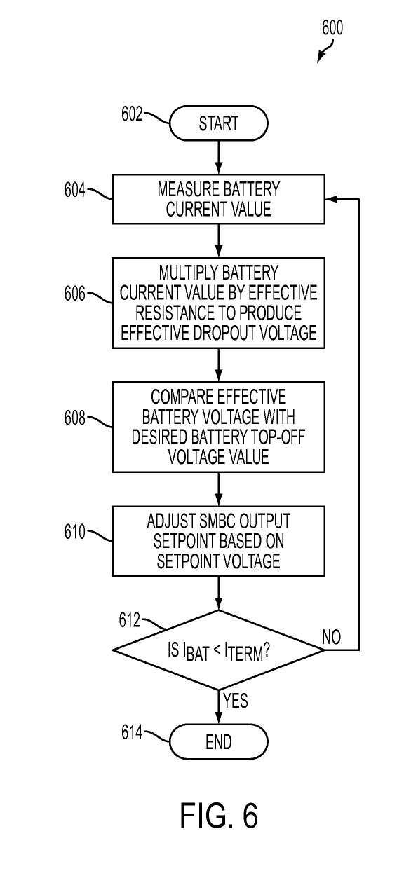

FIG. 6 illustrates the steps of the method of high current battery charging using IR dropout compensation. The method 600 begins with a start step 602, where the device is connected for charging. In step 604 the battery current value is measured. This battery current value is multiplied by the battery effective resistance (Reff) to produce effective dropout voltage in step 606. Dropout voltage is defines as the voltage difference between battery voltage and SMBC output. The next step 608, compares the effective battery voltage with desired battery top-off voltage value. The SMBC output setpoint is adjusted based on the setpoint voltage in step 610. In step 612 Ibat is compared with Iterm. If That is less than Iterm the process ends at step 614. If That is not less than Iterm then the process proceeds back to step 604 where the battery current value is measured and the process begins again. The battery charge will still put out more than 4.2v even if the SMBC voltage is well above the maximum battery voltage. This charging scheme dissolves the traditional constant voltage charging phase. Instead, the SMBC output voltage descends from its peak to the Vmax battery voltage as the battery current reduces to zero.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for charging a lithium-ion battery, comprising:
measuring a battery current value;
multiplying the battery current value by an effective resistance of the battery to produce an effective dropout voltage value;
comparing the effective battery voltage value with a desired battery top off voltage value;
adjusting a switch mode battery charger output set point based on a setpoint voltage;
comparing battery current and terminal current; and
terminating charging if the battery current is less than the terminal current and measuring the battery current value again if the battery current is greater than the terminal current.

2. The method of claim 1, wherein the multiplying of the battery field effect transistor current value by an effective resistance of the battery to produce an effective battery voltage value is performed by a processor.

3. The method of claim 1, wherein a voltage multiplier and a voltage comparator perform the multiplying the battery field effect transistor current value by an effective resistance of the battery to produce an effective battery voltage value.

4. A method for charging a lithium-ion battery, comprising:
sensing a battery voltage via a Kelvin sense at positive and negative terminals at the battery;
comparing the sensed battery voltage value with a desired battery top off voltage value; and
terminating charging if the battery voltage exceeds the desired battery top off value; and
continuing charging if the battery voltage does not exceed the desired battery top off value.

5. An apparatus for charging a lithium-ion battery, comprising:
a battery field effect transistor;
a switch mode battery charger;
a comparator;
a battery management system;
a multiplier; and
a processor.

6. The apparatus of claim 5, wherein the comparator and a low pass filter are provided by a processor internal to a power management integrated circuit.

7. An apparatus for charging a lithium-ion battery, comprising:
means for measuring a battery current value;
means for multiplying the battery current value by an effective resistance of the battery to produce an effective dropout voltage value;
means for comparing the effective battery voltage value with a desired battery top off voltage value;
means for adjusting a switch mode battery charger output set point based on a setpoint voltage;
means for comparing battery current and terminal current; and
means for terminating charging if the battery current is less than the terminal current and measuring the battery current value again if the battery current is greater than the terminal current.

8. The apparatus of claim 7, further comprising processor means for multiplying the battery field effect transistor current value by an effective resistance of the battery to produce an effective battery voltage value.

9. The apparatus of claim 7, further comprising voltage multiplier means and voltage comparator means for multiplying the battery field effect transistor current value by an effective resistance of the battery to produce an effective battery voltage value.

10. An apparatus for charging a lithium-ion battery, comprising:
means for sensing a battery voltage via a Kelvin sense at positive and negative terminals at the battery;
means for comparing the sensed battery voltage value with a desired battery top off voltage value;
means for terminating charging if the battery voltage exceeds the desired battery top of value; and
means for continuing charging if the battery voltage does not exceed the desired battery top off value.

11. A non-transitory computer-readable medium, containing instructions for causing a processor to perform the steps of:
measuring a battery field current value;
multiplying the battery current value by an effective resistance of the battery to produce an effective dropout voltage value;
comparing the effective battery voltage value with a desired battery top off voltage value; and
adjusting a switch mode battery charger output setpoint based on a setpoint voltage;
comparing battery current and terminal current; and
terminating battery charging if battery current is less than terminal current and measuring the battery current value again if the battery current is greater than the terminal current.

12. The non-transitory computer-readable medium of claim 11, further comprising instructions for directing the voltage multiplier and the voltage comparator to multiply the battery field effect transistor current value by the effective resistance of the battery to produce an effective battery voltage value.

13. A non-transitory computer-readable medium for causing a processor to perform the steps of:
sensing a battery voltage via a Kelvin sense at positive and negative terminals at the battery;
comparing the sensed battery voltage value with a desired battery top off voltage value;
terminating charging if the battery voltage exceeds the desired battery top off value; and
continuing charging if the battery voltage does not exceed the desired battery top off value.
